(19) United States
(12) Patent Application Publication
(10) Pub. No.: US 2010/0162121 A1
(43) Pub. Date: Jun. 24, 2010

(54) DYNAMIC CUSTOMIZATION OF A VIRTUAL WORLD

(75) Inventors: John H. Yoakum, Cary, NC (US); Tony McCormack, Galway (IE); Neil O'Connor, Galway (IE)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 12/341,871

(22) Filed: Dec. 22, 2008

(51) Int. Cl. G06F 3/048

(52) U.S. Cl. 715/727

(57) ABSTRACT

A method and apparatus of dynamically customizing a virtual world. A first user and a second user engage in a conversation with respect to a location in the virtual world. A speech processor monitors the conversation and detects that a sound made matches a key sound. The virtual world is altered to include a virtual world customization based on the key sound. The virtual world customization may also be based on user information associated with the user in the conversation that made the sound.

### FIELD OF THE INVENTION

This invention relates to virtual worlds, and in particular to dynamically customizing a virtual world based on a conversation occurring with respect to a location in the virtual world.

### BACKGROUND OF THE INVENTION

A virtual world is a computer simulated environment in which humans typically participate via a computer-rendered entity referred to as an avatar. Virtual worlds have long been associated with entertainment, and the success of several multiplayer online simulations, such as World of Warcraft and Second Life, are evidence of the popularity of virtual worlds. The immersive qualities of virtual worlds are frequently cited as the basis of their popularity. Commercial entities are beginning to explore using virtual worlds for marketing products or services to existing or potential customers. However, currently, in a commercial context, virtual worlds are typically used as a mechanism for enticing a potential customer to contact a representative of the company to discuss the company's products or services, or as a means for strengthening a brand through exposure to users of the virtual world—in essence, as a billboard.

Virtual worlds are increasingly providing voice communication capabilities among users of the virtual world. Headphones with integrated microphones and speakers are commonplace among computer users today, and virtual worlds use voice enabled communications to enable users participating in the virtual world to talk with one another. Some virtual worlds also provide rudimentary voice recognition interfaces, wherein a user of the virtual world can navigate within the virtual world by using a set of predefined commands. However, virtual worlds currently lack the ability to integrate voice with activity occurring in the virtual world in a way that is natural and that enhances a user's experience from a marketing perspective. Therefore, there is a need to combine a virtual world's immersive qualities with a user's voice communications to enable a virtual world to provide a customized experience based on a user's particular interests.

### SUMMARY OF THE INVENTION

The present invention relates to a virtual world that is customized based on a conversation that is associated with the virtual world. A first user of the virtual world and a second user engage in a conversation. The conversation is monitored, and a sound is detected that matches a key sound. A portion of the virtual world is then altered to include a virtual world customization based on the key sound.

The conversation may be monitored by analyzing a media stream including a voice signal of the user and the agent. The media stream may be a single media stream carrying voice signals of both the first and second users, or may be multiple media streams wherein one media stream includes the voice signals of the first user and another media stream includes the voice signals of the second user. The media streams may be analyzed by voice recognition software, such as a speech analytics algorithm, that is capable of real-time or near real-time analysis of conversations.

The second user may comprise an agent associated with an enterprise and be represented in the virtual world by an agent avatar. In an alternate embodiment, the agent may be computer-controlled. The agent may be a human associated with an enterprise depicted in the virtual world. The agent may be one of many agents managing calls associated with the enterprise from a customer contact center. The computer-controlled agent may be programmed to communicate in response to words spoken by the user. The user may be represented in the virtual world by an avatar, and may interact with the virtual world with a user device that includes communication abilities and enables the user to engage in conversation with the agent with respect to a location in the virtual world.

The key sounds may include all or portions of words and phrases that are associated with products available for sale by the enterprise and sounds that provide information about the participants of the conversation including, for example, an emotional state of the user, a dialect associated with a user, an accent associated with a user, and the like.

A virtual world customization made in response to detecting a sound made by a participant that matches a key sound can include, but is not limited to, displaying a video or graphical image in the virtual world, playing an audio stream or other recording in the virtual world, reconfiguring an existing display of virtual objects from a first configuration to a second configuration in the virtual world, including additional virtual objects or removing existing virtual objects in the virtual world, introducing a virtual world environment not previously displayed in the virtual world, or any combination thereof. The particular virtual world customization included in the virtual world may be based on the particular key sound detected. According to one embodiment of the invention, the virtual world customization is also based on user information associated with the participant. For example, if a user communicates that they are interested in “hats,” the present invention may determine from user profile information that the user is a male residing in Reno, Nev., and initially present a virtual world customization comprising a display of men's cowboy hats viewable by the user in the virtual world.

According to another embodiment of the invention, the virtual world customization comprises altering the virtual world to include a virtual world environment that was absent from display in the virtual world prior to detection of the key sound, wherein the virtual world environment includes a display of a product associated with the key sound in an environment that shows a conventional use of the product by a purchaser of the product. For example, a user may indicate an interest in coats, and an agent may ask whether a “parka” may be suitable. Upon detection of the keyword “parka,” the virtual environment viewed by the user may dynamically change to reflect a snow-covered street where avatars wearing parkas are walking. Each parka may bear indicia enabling the user to express an interest about any particular parka. Alternately, the user could be directed to walk through a door that exists in the virtual world and that opens to such a winter setting with models wearing parkas, viewable to the user upon passing through the doorway.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block diagram illustrating a system according to one embodiment of the invention.

FIG. 2 is a block diagram illustrating a speech processor illustrated in FIG. 1 in greater detail.

FIG. 3 is a flow chart illustrating a process for altering a virtual world to include a virtual world customization according to one embodiment of the invention.

FIG. 4 is a flow chart illustrating a process for altering a virtual world to include a virtual world customization according to another embodiment of the invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to dynamically customizing a virtual world based on a conversation occurring with respect to a location of the virtual world. The present invention enables the virtual world to change in response to sounds made by either participant in a conversation. For purposes of illustration, the present invention will be described herein in the context of a commercial entity, or enterprise, providing marketing, sales, or services to existing or potential customers in a virtual world. However, the present invention is not limited to such a commercial context, and has applicability in any context where it would be beneficial to dynamically alter a virtual world based on a conversation between users or participants in the virtual world.

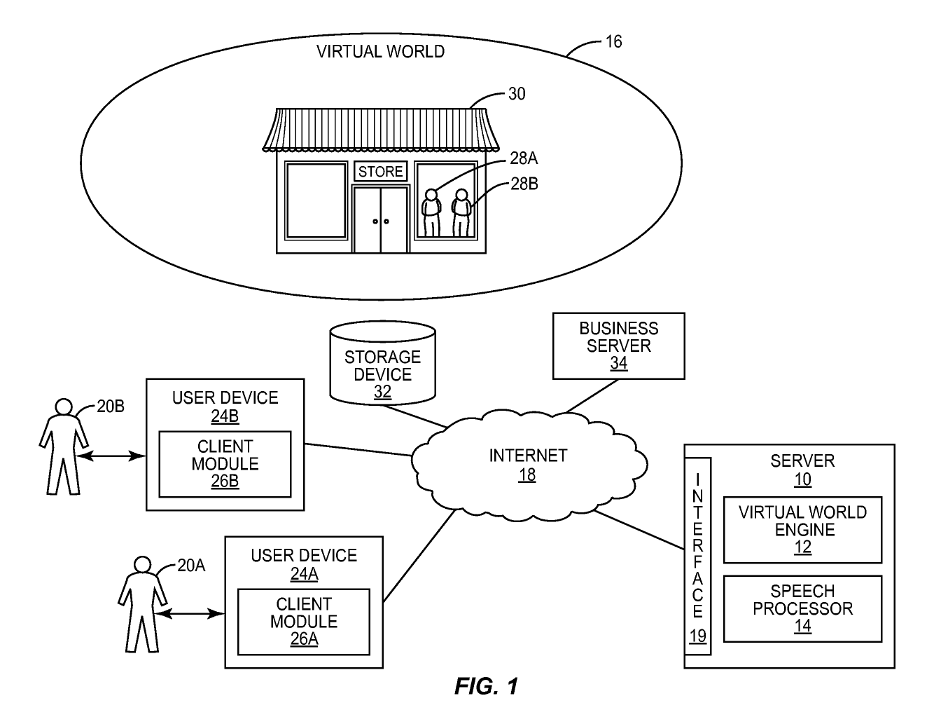

Referring now to FIG. 1, a block diagram of a system according to one embodiment of the invention is illustrated. A server 10 including a virtual world engine 12 and a speech processor 14 provides a virtual world 16. The server 10 can comprise any suitable processing device capable of interacting with a network, such as the Internet 18, via a communications interface 19, and capable of executing instructions sufficient to provide a virtual world 16 and to carry out the functionality described herein. The server 10 can execute any conventional or proprietary operating system, and the virtual world engine 12 and the speech processor 14 can be coded in any conventional or proprietary software language. Users 20A, 20B participate in the virtual world 16 using user devices 24A, 24B, respectively. Throughout the specification where the Figures show multiple instances of the same element, such as the users 20A, 20B, the respective element may be referred to collectively without reference to a specific instance of the element where the discussion does not relate to a specific element. For example, the users 20A, 20B may be referred to collectively as the users 20 where the discussion does not pertain to a specific user 20, and the user devices 24A, 24B may be referred to collectively as the user devices 24 where the discussion does not pertain to a specific user device 24. The user devices 24 may comprise any suitable processing device capable of interacting with a network, such as the Internet 18, and of executing a client module 26 suitable to interact with the server 10. The client module 26 also provides the virtual world 16 for display on a display device (not shown) to a respective user 20. The user devices 24 could comprise, for example, personal computers, cell phones, personal digital assistants, a fixed or mobile gaming console, and the like. The user devices 24 may connect to the Internet 18 using any desired communications technologies, including wired or wireless technologies, and any suitable communication protocols, such as Transmission Control Protocol/Internet Protocol (TCP/IP) or Sequenced Packet Exchange/Internetwork Packet Exchange (SPX/IPX). While the invention is described herein as using a public network, such as the Internet 18, to enable communications between the server 10 and the user devices 24, any network that enables such communications, private or public, conventional or proprietary, could be used with the present invention.

The users 20 are typically represented in the virtual world 16 through the use of a computer-rendered entity known as an avatar. An avatar is essentially a representation of the respective user 20 within the virtual world 16, and indicates a location with respect to the virtual world 16 of the respective user 20. Avatars 28A, 28B represent the users 20A, 20B, respectively, in the virtual world 16. The client modules 26 receive instructions from the users 20, typically via an input device such as a mouse, a toggle, a keyboard, and the like, to move a respective avatar 28 about the virtual world 16. In response to a particular request to move an avatar 28, the respective client module 26 renders the virtual world 16 to show movement of the avatar 28 to the respective user 20 within the context of the virtual world 16, and also provides movement data to the virtual world engine 12. The virtual engine world 12 collects information from the client modules 26, and informs the client modules 26 of events occurring that may be within an area of interest of the respective avatar 28 controlled by the respective client module 26. As is understood by those skilled in the art, such information is typically communicated between a client module 26 and virtual world engine 12 in the form of messages. For example, if the user 20A moves the avatar 28A from one side of a room in the virtual world 16 to the other side of the room, the client module 26A will provide this movement information to the virtual world engine 12, which in turn will provide the movement information to the client module 26B, which can then render the virtual world 16 showing the movement of the avatar 28A to the user 20B.

The virtual world 16 may be a virtual world that provides access to a large number of users for a social interaction purpose, such as Second Life, in the context of a competitive or collaborative game, such as World of Warcraft, or may provide access for a more limited purpose such as the provision of services for a particular commercial enterprise. In order to participate in the virtual world 16, it may be necessary to perform an installation process that involves preloading certain content onto the user devices 24, such as, for example, downloading the client modules 26 onto the user devices 24 as well as graphical content relating to the virtual world 16. Alternately, the process for downloading the client modules 26 may be dynamic and practically transparent to the users 20, such as, for example, where the client module 26 is automatically downloaded by virtue of a connection to a particular website, and the client module 26 runs in a browser used by the user 20 to interact with websites on the Internet 18.

The virtual world engine 12 enables speech communications among users within the virtual world 16. As such, the user devices 24 preferably include speech enabling technology. Typically, a user 20 uses a headset (not shown) that includes an integrated microphone and that is coupled, wired or wirelessly, to the user device 24. For example, the user 20A may speak into the microphone, causing the user device 24A to generate a media stream of the voice signal of the user 20A that is provided by the client module 26A to the virtual world engine 12. The virtual world engine 12, determining that the avatar 28B is within an auditory area of interest of the avatar 28A, may provide the media stream to the client module 26B for playback by the user device 24B to the user 20B. A similar process following the reverse path from the user device 24B to the virtual world engine 12 to the user device 24A will be followed if the user 20B decides to respond to the user 20A. In this manner, the user 20A may engage in a conversation with the user 20B.

The users 20A, 20B could be any type of participants in the virtual world 16, including acquaintances such as mutual friends exploring the virtual world 16 collaboratively, or strangers who happen upon one another in the virtual world 16. According to one embodiment of the present invention, a user, such as the user 20B, may be a representative, or agent, of a commercial enterprise, or entity, that is depicted or otherwise portrayed in the virtual world 16. For example, the avatar 28B may be in a clothing store 30 that is depicted in the virtual world 16. Upon detection of the avatar 28A in or about the clothing store 30, the user 20B may initiate a conversation with the user 20A. The virtual world engine 12 may enable such communications either automatically, based on a virtual world proximity between the avatars 28A and 28B, or may first require an explicit request and approval between the users 20A and 20B through the use of dialog boxes or the like, prior to enabling such conversations. The virtual world engine 12, upon enabling such communications, also provides the voice signals generated by the users 20A and 20B to the speech processor 14. The speech processor 14 can comprise any suitable speech recognition processor capable of detecting sounds in speech signals. Sounds and key sounds, as used herein, can include, but are not limited to, words, phrases, combinations of words occurring within a predetermined proximity of one another, utterances, names, nick names, unique pronunciations, accents, dialects, and the like. According to one embodiment of the invention, the speech processor 14 comprises phonetic-based speech processing. Phonetic-based speech processing has the capability of detecting sounds in conversations quickly and efficiently. For basic information on one technique for parsing speech into phonemes, please refer to the phonetic processing technology provided by Nexidia Inc., 3565 Piedmont Road NE, Building Two, Suite 400, Atlanta, Ga. 30305 (www.nexidia.com), and its white paper entitled Phonetic Search Technology, 2007 and the references cited therein, wherein the white paper and cited references are each incorporated herein by reference in their entireties. While shown herein as an integral portion of the server 10, the speech processor 14 may be implemented on a separate device that is coupled to the server 10 via a network, such as the Internet 18.

Assume the user 20A has moved the avatar 28A into the clothing store 30 and the user 20B asks the user 20A whether the user 20A needs assistance. The avatars 28A and 28B may be surrounded by displays of certain types of virtual object products, such as shirts and pants. The user 20A may respond that they are interested in whether the clothing store 30 carries shoes. The speech processor 14 monitors the conversation between the users 20A and 20B. Each sound detected by the speech processor 14 may be matched against a list of key sounds to determine whether the detected sound matches a key sound. Assume that the sound “shoe” is a key sound. Upon determining that the sound “shoe” matches a key sound, the speech processor 14 signals the virtual world engine 12 that a key sound has been detected, and provides the virtual world engine 12 a unique index identifying the respective key sound. The virtual world engine 12, according to one embodiment of the invention, determines a virtual world customization that is associated with the key sound “shoe.” The virtual world customization may comprise any suitable alteration of the virtual world 16, and can comprise, for example, display of a video or graphical image in the virtual world 16, playing of an audio stream or other recording in the virtual world 16, reconfiguration of an existing display of virtual objects from a first configuration to a second configuration in the virtual world 16, inclusion of additional virtual objects or removal of existing virtual objects in the virtual world 16, introduction of a virtual world environment not previously displayed in the virtual world 16, or any combination thereof.

The virtual world engine 12 determines that the virtual world customization associated with the key sound “shoe” comprises altering the virtual world 16 to include a table bearing a plurality of different types of shoes. The imagery associated with the virtual world customization may be stored on a storage device 32 and coupled to the virtual world engine 12 directly, or via a network, such as the internet 18. The virtual world engine 12 provides the imagery to the user device 24A, which in turn may render, according to instructions, the shoe display in place of an existing display in a location viewable by the user 20A. While the virtual world customization may appear to the user 20A to simply ‘appear’ in the virtual world 16 in front of the avatar 28A, the virtual world customization may similarly be rendered with respect to a location of the avatar 28A such that the user 20A may direct the avatar 28A to a different location within the clothing store 30, or through a door, for example, to view the virtual world customization.

According to another embodiment of the present invention, the virtual world customization may be based on the key sound and based on information known or discernable about the user 20A. For example, the user 20A may be an existing customer of the business enterprise depicted as the clothing store 30 and the business enterprise may have data showing that the user 20A ordinarily purchases running shoes. The virtual world engine 12 may have local access to such information in the storage device 32 or, where the business entity is one of several business entities depicted in the virtual world 16, such as for example where the virtual world 16 is a shopping mall, may have access to a business server 34 associated with the respective business. In cases where the user 20B is a contact center agent for a business enterprise, the user information stored in the business server 34 belonging to the business enterprise will be available to the user 20B and can be made available to the server 10 for use in the virtual world 16 as appropriate. The virtual world engine 12 in conjunction with the speech processor 14 may provide information including the detection of the key sound “shoe” and an identifier identifying the user 20A to the business server 34. The business server 34 may determine that the user 20A typically purchases running shoes, and provide that information to the virtual world engine 12. The virtual world engine 12 may then select a virtual world customization relating solely to running shoes in lieu of a virtual world customization that relates to a plurality of different types of shoes.

The user 20A may view the display of running shoes and indicate they are not interested in running shoes. The user 20B, a contact center agent sitting in front of a computer, may view a record of purchases of the user 20A and note that the user 20A previously purchased cowboy boots on several occasions, and may ask whether the user 20A is interested in cowboy boots. The speech processor 14 may determine that the sound “cowboy boots” is a key sound and identify the key sound to the virtual world engine 12. The virtual world engine 12 may determine that a virtual world customization associated with cowboy boots involves altering the virtual world 16 to include a display of cowboy boots. The virtual world engine 12 obtains the imagery, or skin, associated with cowboy boots from the storage device 32, provides the imagery to the user device 24A, which in turn renders the new display of cowboy boots for the user 20A. In this manner, the present invention dynamically customizes the virtual world 16 based on a conversation between the user 20A and the user 20B. Notably, the virtual world 16 may be altered based on sounds made by either the user 20A, the user 20B, or a combination of sounds made by both users 20A, 20B.

While for purposes of illustration several examples of virtual world customizations are provided, it should be apparent to those skilled in the art after reading the present disclosure that a virtual world customization can range from a subtle change to the virtual world 16, or a complete re-skinning of portions of the virtual world 16. For example, based on detection of one or more key sounds, the virtual world customization may include changing the wall color of the clothing store 30, altering the content of posters hanging on the walls, changing dynamic information, such as data feeds that are being shown on a virtual flat screen television portrayed in the clothing store 30, and the like. The virtual world customization can occur within a portion of the virtual world 16 that is immediately visible to the respective user 20 without any movement of the respective avatar 28, or within a portion of the virtual world 16 that the user 20 will view as the avatar 28 moves about the virtual world 16.

While the user 20B may be a human, alternately, the user 20B may be a computer-controlled agent. For example, the virtual world engine 12 may control the avatar 28B and, upon detection of a proximity of the avatar 28A, engage the user 20A in a conversation using artificial intelligence. The process as described above with respect to a human user 20B would otherwise be the same, with the conversation between the computer-controlled user 20B and the user 20A being monitored by the speech processor 14, and the virtual world engine 12 altering the virtual world 16 by including a virtual world customization based on the detection of key sound by either the computer-controlled user 20B or the user 20A.

According to another embodiment, the virtual world engine 12 may provide a computer-controlled avatar 28B until a certain key sound is detected by the speech processor 14 that the virtual world engine 12 uses to initiate a process to contact a human, such as a contact center agent, to take over the control of the avatar 28B and the conversation with the user 20A. For example, the detection of certain key sounds, such as “purchase,” “see,” “do you have,” and the like, may be deemed of sufficient interest that it warrants the resources of a human to engage the user 20A. For teachings relating to using a human contact center agent in the context of a virtual world, please see U.S. patent application Ser. No. 11/608,475, filed Dec. 8, 2006 entitled PROVISION OF CONTACT CENTER SERVICES TO PLAYERS OF GAMES, which is hereby incorporated by reference herein.

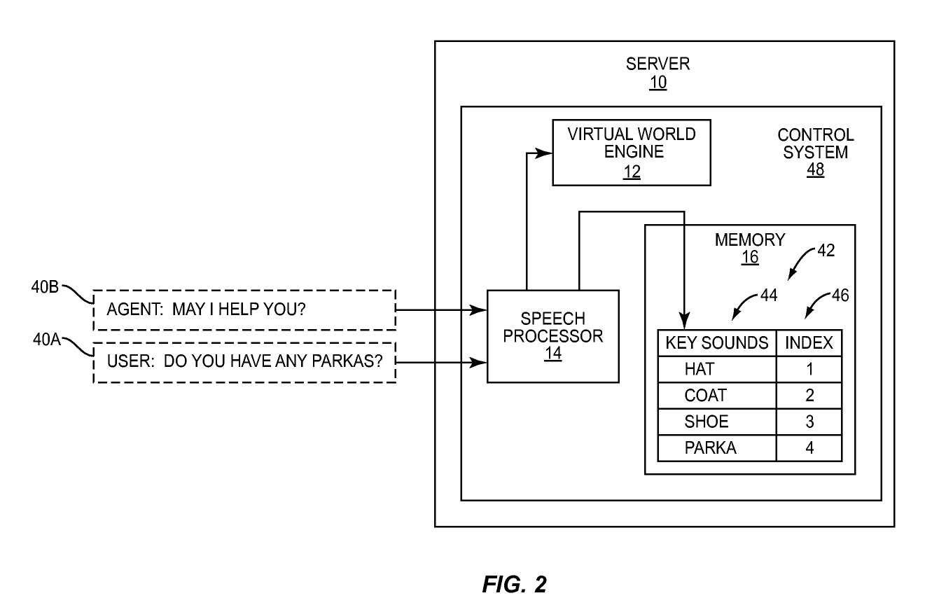

FIG. 2 is a block diagram illustrating aspects of the speech processor 14 in greater detail. The speech processor 14 receives one or more media streams 40A, 40B, representing voice signals made by the users 20A, 20B respectively. While shown in FIG. 2 as separate voice signals for purposes of illustration, the voice signals could be presented to the speech processor 14 as a single media stream 40 including voice signals from both users 20A, 20B. Further, while the embodiment herein has been shown as having two users 20 engaged in a conversation, the present invention could be used with any number of users 20 engaging in a conversation. The speech processor 14 monitors the conversation by analyzing the media streams 40A, 40B. The speech processor 14 detects sounds and determines whether any of the sounds match a key sound. Key sounds may be stored in a key sound table 42. The key sound table 42 may include a key sound column 44 containing rows of individual key sounds, and an index column 46 containing rows of unique identifiers, each of which is associated with a unique key sound. While not shown in the key sound table 42, data may also be present that define a key sound as comprising multiple sounds, and may further include data defining a key sound as multiple sounds occurring within a proximity of one another. While for purposes of illustration the key sounds in the key sound column 44 are represented as simple words, it will be understood by those skilled in the art that the key sounds may comprise data representing phonetic components of speech, waveforms, or any other data suitable for representing a sound that may be made during a conversation. The server 10 also includes a control system 48, which includes a processor for executing the various software suitable for implementing the virtual world engine 12 and the speech processor 14 modules, and inter process communication capabilities suitable for enabling communications between the various modules.

Assume that the speech processor 14 detects the sound “parkas” in the media stream 40A. The speech processor 14 initiates a table lookup on the key sound table 42 and determines that the sound “parkas” matches the key sound “parka.” Notably, the detected sound in the media stream 40A may match a key sound even if the detected sound is not identical to the key sound, for example where the key sound is in singular form and the detected sound is in plural form. The speech processor 14 also determines that the index associated with the key sound “parka” is “4.” The speech processor 14 sends the index “4” and an identifier identifying the user 20A as the source of the key sound to the virtual world engine 12. As discussed previously with respect to FIG. 1, the virtual world engine 12 may use one or both of the key sound index and the user identifier to determine a virtual world customization to include in the virtual world 16.

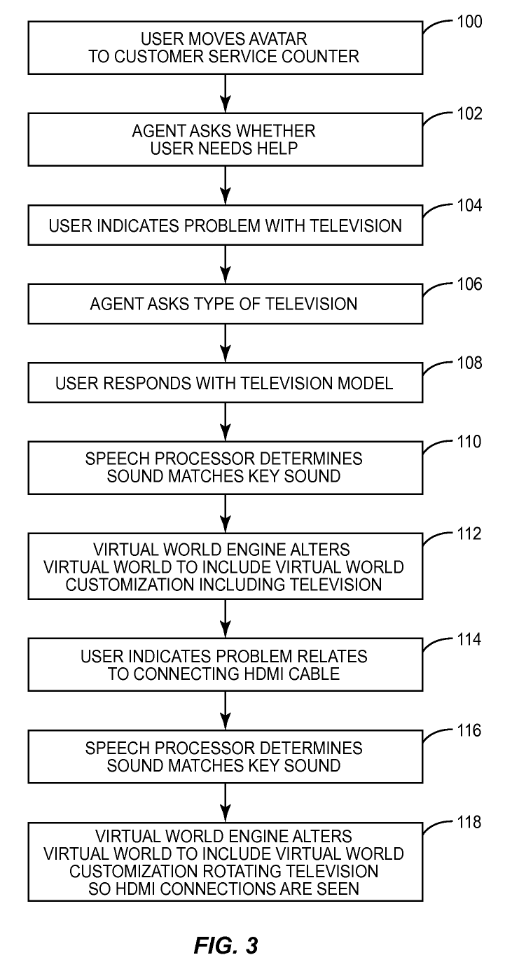

FIG. 3 is a flow chart illustrating a process for altering a virtual world to include a virtual world customization according to one embodiment of the present invention. Assume that the present embodiment relates to a business entity providing customer support via the virtual world 16. The user 20A may direct a browser on the user device 24A to connect to a website associated with the business enterprise. Upon connection to the website, a Java code client module 26A may be loaded onto the user device 24A and imagery representing the virtual world 16 may be loaded into the client module 26A for display to the user 20A. A default avatar may be available and be shown in the virtual world 16, or alternately, the user 20A may be able to select an avatar from a number of avatars provided by the virtual world 16. Assume further that the virtual world 16 is in essence a virtual store associated with the business enterprise, for example a large electronics store. The user 20A moves the avatar 28A through the business enterprise in the virtual world 16 to a counter identified as a “customer service” counter (step 100). Assume further that the business enterprise maintains a number of human agents who continually monitor the virtual world 16 for avatars that approach various areas of the business enterprise in the virtual world 16 or, alternately, are alerted when a user avatar 28 is within a proximity of a specific area in the virtual world 16.

A human agent associated with the customer service counter and represented in the virtual world 16 by the avatar 28B initiates a conversation with the user 20A and asks the user 20A whether the user 20A requires any help (step 102). The user 20A indicates that he is having a problem with a television (step 104). The agent asks the user 20A for the model or type of television with which the user 20A is having a problem (step 106). The user 20A responds with a particular television model (step 108). The speech processor 14, which is monitoring the conversation between the agent and the user 20A, determines that the sound associated with the television model number matches a key sound in the key sound table 42 (step 110). The speech processor 14 provides a key sound index to the virtual world engine 12. The virtual world engine 12 determines that a virtual world customization associated with the key sound relates to providing a three-dimensional image of the particular television model with which the user 20A is having a problem on the countertop (step 112). The user 20A sees the three-dimensional rendering of the television appear on the counter. The user 20A indicates to the agent that the problem relates to connecting a High-Definition Multimedia Interface (HDMI) cable (step 114). The speech processor 14 determines that the sound “HDMI” matches a key sound (step 116), and provides a key sound index associated with the key sound to the virtual world engine 12. The virtual world engine 12 determines that the virtual world customization associated with the “HDMI” key sound is to rotate the television shown on the counter such that the portion of the television in which cables are inserted is shown so that the agent and the user 20A can see where HDMI cables are plugged into the television (step 118).

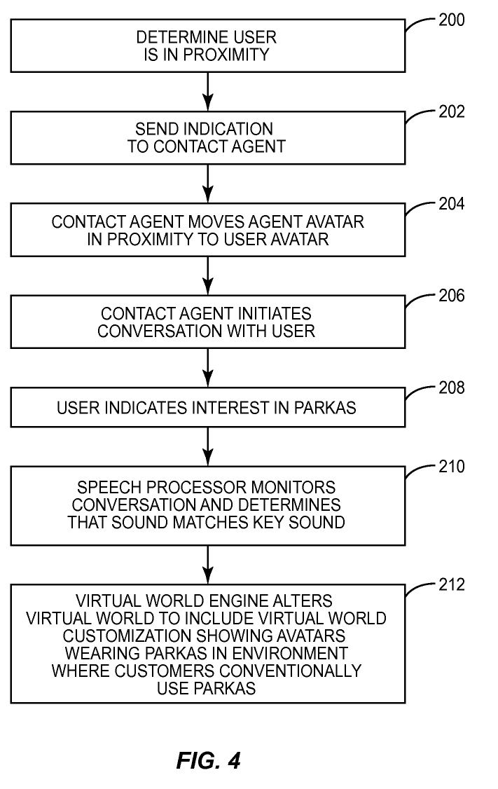

FIG. 4 is a flow chart illustrating a process for altering a virtual world to include a virtual world customization according to another embodiment of the invention. Assume in this embodiment that the virtual world 16 is a shopping mall and the user 20A moves the avatar 28A into a store of a business depicted in the shopping mall. Assume further that the respective business does not maintain human users 20 to monitor the virtual world 16, but rather maintains a contact center of agents that can be contacted automatically by the virtual world engine 12 upon the determination that an avatar has entered the store.

The virtual world engine 12 determines that the avatar 28A is within a particular proximity of the virtual world enterprise (step 200). The virtual world engine 12 sends a notification to the business server 34 that an avatar 28 is in proximity of the virtual world enterprise (step 202). A contact agent is notified via the business server 34 and moves the avatar 28B in proximity to the avatar 28A (step 204). The contact agent initiates a conversation with the user 20A and asks, for example, whether the user 20A is interested in any particular type of clothing (step 206). The user 20A indicates an interest in purchasing a parka (step 208). The speech processor 14 monitors the conversation and determines that the sound “parka” matches the key sound “parka” (step 210). The speech processor 14 then provides an index associated with the key sound “parka” to the virtual world engine 12. The virtual world engine 12 determines that the virtual world customization associated with the key sound “parka” involves altering the virtual world 16 to include a virtual world customization showing avatars 28 wearing parkas in an environment where customers conventionally use parkas (step 212). In this particular customization, the virtual world engine 12 changes the imagery from a virtual world enterprise to a snow covered street nestled in the mountains where avatars are modeling various parkas sold by the virtual world enterprise. Each parka may bear some indicia by which the user 20A, upon determining an interest in a particular parka, can request to see.

In an alternate embodiment, assume that the users 20A, 20B are two friends located geographically apart, but who are exploring the virtual world 16 together. Assume that the avatars 28A, 28B move into the clothing store 30 and the user 20A indicates to the user 20B that the user 20A finds certain belts to be “too formal.” The user 20B responds that he wishes the clothing store 30 carried braided belts. The speech processor 14 monitors the conversation and determines that the sound “braided belt” matches a key sound. The speech processor 14 provides an index associated with the key sound “braided belt” to the virtual world engine 12. The virtual world engine 12 determines that the virtual world customization associated with the key sound “braided belt” involves altering the virtual world 16 to include a display of hanging braided belts and playing modern rock music. The display appears in front of the users 20A, 20B, and music being played in the clothing store 30 changes from classical music to modern rock music.

Those skilled in the art will recognize improvements and modifications to the preferred embodiments of the present invention. All such improvements and modifications are considered within the scope of the concepts disclosed herein and the claims that follow.

What is claimed is:

1. A method comprising:
providing a virtual world;
monitoring a conversation between a first user of the virtual world with respect to a location in the virtual world and a second user of the virtual world;
detecting in the conversation at least one sound;
making a determination that the at least one sound matches one of a plurality of key sounds; and
in response to the determination, altering a portion of the virtual world to include a virtual world customization based on the one of the plurality of key sounds.

2. The method of claim 1 wherein the second user comprises a contact center representative associated with a business depicted in the virtual world.

3. The method of claim 1 wherein the second user is computer-controlled.

4. The method of claim 1 wherein the second user is an acquaintance of the first user.

5. The method of claim 1 wherein monitoring the conversation further comprises analyzing a first media stream comprising a voice signal generated by the user and a second media stream comprising a voice signal generated by the second user.

6. The method of claim 1 wherein the at least one sound comprises a distinctive style of pronunciation of a person from a particular area, country, or social background.

7. The method of claim 1 wherein the at least one sound was made by the first user.

8. The method of claim 1 wherein the at least one sound was made by the second user.

9. The method of claim 1 wherein detecting in the conversation at least one sound further comprises detecting, via a phoneme-based speech analytics process, the at least one sound.

10. The method of claim 1 further comprising determining the virtual world customization based on the one of the plurality of key sounds.

11. The method of claim 10 further comprising determining the virtual world customization based on the one of the plurality of key sounds and user information associated with one of the first user and the second user.

12. The method of claim 1 wherein altering the portion of the virtual world to include the virtual world customization based on the one of the plurality of key sounds comprises presenting in the virtual world one or more products absent from the virtual world prior to detecting the at least one sound.

13. The method of claim 1 wherein altering the portion of the virtual world to include the virtual world customization based on the one of the plurality of key sounds comprises presenting in the virtual world one or more items absent from display in the virtual world prior to detecting the at least one sound.

14. The method of claim 13 wherein the one or more items comprise one or more products associated with a business depicted in the virtual world.

15. The method of claim 1 wherein altering the portion of the virtual world to include the virtual world customization based on the one of the plurality of key sounds comprises presenting in the virtual world a virtual environment absent from display in the virtual world prior to detecting the at least one sound, wherein the virtual environment includes a display of a product associated with the at least one sound presented in an environment showing a conventional use of the product by a purchaser of the product.

16. A server comprising:
a communications interface adapted to communicate with a network; and
a control system adapted to:
provide a virtual world;
monitor a conversation between a first user of the virtual world with respect to a location in the virtual world and a second user of the virtual world;
detect in the conversation at least one sound;
making a determination that the at least one sound matches one of a plurality of key sounds; and
in response to the determination, alter a portion of the virtual world to include a virtual world customization based on the one of the plurality of key sounds.

17. The server of claim 16 wherein the second user comprises a contact center representative associated with a business depicted in the virtual world.

18. The server of claim 16 wherein to monitor the conversation the control system is further adapted to analyze a first media stream comprising a voice signal generated by the first user and a second media stream comprising a voice signal generated by the second user.

19. The server of claim 16 wherein the at least one sound was made by the second user.

20. The server of claim 16 wherein to detect in the conversation the at least one sound the control system is further adapted to detect, via a phoneme-based speech analytics process, the at least one sound.

21. The server of claim 16 wherein the virtual world customization is based on the one of the plurality of key sounds and user information associated with one of the first user and the second user.

22. The server of claim 16 wherein to alter the portion of the virtual world to include the virtual world customization based on the one of the plurality of key sounds the control system is further adapted to present in the virtual world one or more products absent from the virtual world prior to detecting the at least one sound.

23. The server of claim 16 wherein to alter the portion of the virtual world to include the virtual world customization based on the one of the plurality of key sounds the control system is further adapted to present in the virtual world one or more items absent from display in the virtual world prior to detecting the at least one sound.

24. The server of claim 23 wherein the one or more items comprise one or more products associated with a business depicted in the virtual world.

25. The server of claim 16 wherein to alter the portion of the virtual world to include the virtual world customization based on the one of the plurality of key sounds the control system is further adapted to present in the virtual world a virtual environment absent from display in the virtual world prior to detecting the at least one sound, wherein the virtual environment includes a display of a product associated with the at least one sound presented in an environment showing a conventional use of the product by a purchaser of the product.
